(19) United States
(12) Patent Application Publication
(10) Pub. No.: US 2019/0156850 A1
(43) Pub. Date: May 23, 2019

(54) NOISE SUPPRESSOR AND METHOD OF IMPROVING AUDIO INTELLIGIBILITY

(71) Applicant: SAMSUNG ELECTRONICS CO., LTD., Suwon-si (KR)

(72) Inventors: Holly FRANCOIS, Staines (GB); Ki-hyun CHOO, Seoul (KR)

(73) Assignee: SAMSUNG ELECTRONICS CO., LTD., Suwon-si (KR)

(21) Appl. No.: 16/314,287

(22) PCT Filed: Mar. 14, 2017
(86) PCT No.: PCT/KR2017/002722

§ 371 Date: Dec. 28, 2018

(30) Foreign Application Priority Data
Jul. 12, 2016 (GB) 1612109.7

(51) Int. Cl. G10L 21/0216; G10L 21/0364; G10L 25/84

(52) U.S. Cl. CPC G10L 21/0216; G10L 25/84; G10L 21/0364

(57) ABSTRACT

There is provided a noise suppressor 2 comprising a receiver 4 operable to receive an input audio signal 14 and to produce from the input audio signal 14 a first signal 16 and a second signal 18, the input audio signal 14 comprising desired audio and transmission end noise. The noise suppressor 2 further comprises a first processor 6 operable to perform a first process on the first signal 16, the first process comprising noise suppression to remove at least a portion of the transmission end noise from the first signal 16 before outputting the first signal 16 to a first audio channel 10. The noise suppressor further comprises a second processor 8 operable to perform a second process on the second signal 18, the second process comprising outputting the second signal 18 to a second audio channel 12. The first process comprises more aggressive noise suppression than the second process.

### 1. FIELD

The present invention relates to a noise suppressor and, in particular but not exclusively, a noise suppressor for a device for receiving audio calls.

### 2. DESCRIPTION OF RELATED ART

Transmitter end noise (also known as talker end noise) is very distracting for a listener. It makes it difficult for a listener to distinguish desired audio from noise, which can increase the effort required to hold a telephone conversation. For this reason, transmission end noise suppression is used in mobile phones to reduce the transmitter-end noise before a speech signal is transmitted during a call.

Transmission end noise suppression has an inherent trade off between the reduction in noise and the damage which occurs to the desired audio. This is because the first stage of noise suppression involves forming an estimate of the noise, which is rarely pure, as it often contains some of the desired speech.

Various algorithms have been proposed over the years to improve this trade-off, but it is never completely removed, so most mobile phone manufacturers reach a compromise with a modest amount of transmission noise suppression and reasonable quality audio.

In mobile phones in which the transmission end noise suppression is carried out before the speech signal is transmitted, the receiver mobile phone has no control over, or knowledge of, the noise suppression, as the noise suppression algorithms used in phones differ considerably. Additionally, the user of a mobile phone is not aware of any improvement in speech transmitted from their phone, so is reluctant to pay for an improved algorithm. This reduces the incentives for mobile phone manufacturers to improve the algorithms.

### SUMMARY

It is an aim of the present invention to address at least one problem associated with the prior art, whether referred to herein or otherwise.

According to one aspect of the present invention, there is provided a noise suppressor, comprising a receiver operable to receive an input audio signal and to produce from the input audio signal a first signal and a second signal, the input audio signal comprising desired audio and transmission end noise, a first processor operable to perform a first process on the first signal, the first process comprising noise suppression to remove at least a portion of the transmission end noise from the first signal before outputting the first signal to a first audio channel and a second processor operable to perform a second process on the second signal, the second process comprising outputting the second signal to a second audio channel, wherein the first process comprises more aggressive noise suppression than the second process.

This noise suppressor exploits the principle of binaural processing, to provide a perceived spatial separation of the desired audio and the transmission end noise to a listener. When the first and second audio channels are arranged spatially on opposite sides of the listener (possibly through headphones or speakers), the listener perceives undistorted speech playing on the side of the second audio channel, spatially separated from the noise. This means that even though the overall level of noise has not been reduced, the spatial separation of the received audio from the received noise results in speech that is more intelligible and can be understood with less effort. This avoids the trade off between noise suppression and speech quality associated with conventional noise suppression algorithms.

### BRIEF DESCRIPTION OF THE DRAWINGS

FIG. 1 is a schematic diagram of a noise suppressor.

FIG. 2 is a flowchart illustrating steps performed by the noise suppressor of FIG. 1 according to an example embodiment of the present invention.

### DETAILED DESCRIPTION

According to one aspect of the present invention, there is provided a noise suppressor, comprising a receiver operable to receive an input audio signal and to produce from the input audio signal a first signal and a second signal, the input audio signal comprising desired audio and transmission end noise, a first processor operable to perform a first process on the first signal, the first process comprising noise suppression to remove at least a portion of the transmission end noise from the first signal before outputting the first signal to a first audio channel and a second processor operable to perform a second process on the second signal, the second process comprising outputting the second signal to a second audio channel, wherein the first process comprises more aggressive noise suppression than the second process.

According to one aspect of the present invention, there is provided a noise suppressor, comprising a receiver operable to receive an input audio signal and to produce from the input audio signal a first signal and a second signal, the input audio signal comprising desired audio and transmission end noise, a first processor operable to perform a first process on the first signal, the first process comprising noise suppression to remove at least a portion of the transmission end noise from the first signal before outputting the first signal to a first audio channel and a second processor operable to perform a second process on the second signal, the second process comprising outputting the second signal to a second audio channel, wherein the first process comprises more aggressive noise suppression than the second process.

This noise suppressor exploits the principle of binaural processing, to provide a perceived spatial separation of the desired audio and the transmission end noise to a listener. When the first and second audio channels are arranged spatially on opposite sides of the listener (possibly through headphones or speakers), the listener perceives undistorted speech playing on the side of the second audio channel, spatially separated from the noise. This means that even though the overall level of noise has not been reduced, the spatial separation of the received audio from the received noise results in speech that is more intelligible and can be understood with less effort. This avoids the trade off between noise suppression and speech quality associated with conventional noise suppression algorithms.

In an example, the noise suppression of the first process is aggressive noise suppression. In an example, the second process does not comprise noise suppression. These features increase the difference in the level of noise suppression between the first and second signals, which further increases the perceived spatial separation of noise and audio.

In an example, the first process further comprises introducing a time delay to the first signal before outputting the first signal to the first audio channel. This further increases the perceived spatial separation.

In an example, the time delay is at least 0.6 ms. This time difference increases the perceived spatial separation, as 0.6 ms is approximately the time difference that is experienced between ears when a sound is at one side of a listener's head (i.e. the approximate delay caused by sound travelling from one side of the head to the other). In an example, the time delay is approximately 10 ms.

In an example, the input audio signal is a mono audio signal, and the receiver is operable to duplicate the input audio signal to produce the first signal and the second signal. Where the signal to be duplicated is an analogue signal, the receiver is operable to duplicate the input audio signal by splitting the input audio signal to produce the first signal and the second signal. Where the signal to be duplicated is a digital signal, the receiver is operable to duplicate the input audio signal by copying the input audio signal to produce the first signal and the second signal.

In an example, the input audio signal is a stereo audio signal comprising a first input signal and a second input signal, and the receiver is operable to use the first input signal as the first signal and the second input signal as the second signal.

In an example, the noise suppression of the first process is carried out using a Weiner filter.

In an example, the input audio signal is a speech signal. In an example, the receiver comprises a decoder operable to decode the input audio signal. In an example, the decoder is an Enhanced Voice Services decoder.

In an example, wherein the first audio channel is operable to supply the first signal to a first speaker of a pair of headphones and the second audio channel is operable to supply the second signal to a second speaker of the pair of headphones.

In an example, the second speaker is connected to an in-line microphone. This reduces that the likelihood that the listener will listen to only the first speaker, which reduces the likelihood of the user listening to the aggressively noise suppressed signal which has reduced audio intelligibility.

According to the present invention in another aspect, there is provided a mobile phone comprising the noise suppressor of any preceding claim.

According to the present invention in still another aspect, there is provided a method of improving audio intelligibility comprising receiving an input audio signal and producing from the input audio signal a first signal and a second signal, the input audio signal comprising desired audio and transmission end noise, performing a first process on the first signal, the first process comprising noise suppression to remove at least a portion of the transmission end noise from the first signal before outputting the first signal to a first audio channel and performing a second process on the second signal, the second process comprising outputting the second signal to a second audio channel, wherein the first process comprises more aggressive noise suppression than the second process to provide a perceived spatial separation of the desired audio and the transmission end noise to a listener.

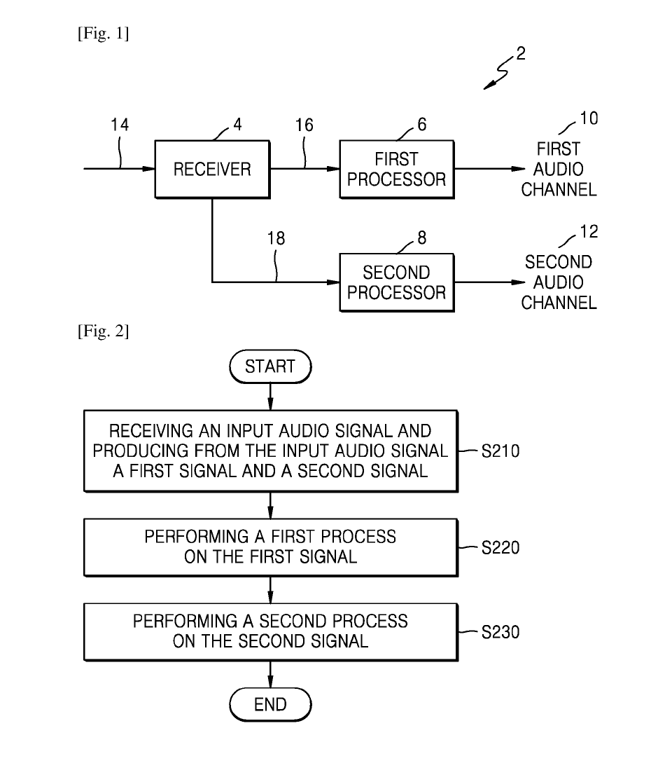

Embodiments of the present invention will now be described, by way of example only, with reference to FIG. 1 and FIG. 2.

Referring to FIG. 1, there is shown a schematic diagram of a noise suppressor 2. The noise suppressor comprises a receiver 4, in communication with a first processor 6 and a second processor 8. The first processor 6 connects to a first audio channel 10. The second processor 8 connects to a second audio channel 12. The noise suppressor 2 makes up part of a first mobile phone.

In use, the receiver 4 receives an input audio signal 14. The input audio signal 14 comprises a mono audio signal. The input audio signal 14 is a speech signal. The input audio signal 14 is transmitted to the first mobile phone from a second mobile phone during a phone call. As such, the input audio signal 14 is encoded, having been encoded by the second mobile phone before transmission. Additionally, the input audio signal 14 is likely to have undergone gentle noise suppression in the second mobile phone before transmission. However, the input audio signal 14 is still a noisy signal, comprising desired audio and transmission end noise. It will be appreciated that the noise suppressor 2 may be used even when the input audio signal 14 has not undergone any noise suppression or encoding.

The receiver 4 comprises a decoder, which decodes the input audio signal 14. The decoder is an Enhanced Voice Services decoder. The receiver 4 duplicates the decoded audio signal to produce a first signal 16 and a second signal 18. The first signal 16 is sent to the first processor 6. The second signal 18 is sent to the second processor 8.

The first processor 6 performs a first process on the first signal 16. The first process comprises noise suppression to remove at least a portion of the transmission end noise from the first signal 16. The noise suppression of the first process is aggressive noise suppression. This means that the parameters of the noise suppression have been selected to prioritise removing the noise, even if this means that the speech is audibly degraded. In contrast, gentle or conservative noise suppression means selecting parameters to ensure no loss of speech quality, even if this means that most or possibly all of the noise remains.

The aggressive noise suppression significantly attenuates the transmission end noise of the first signal 16, but also degrades the desired audio. The noise suppression of the first process is carried out using a Weiner filter. However, it will be appreciated that other noise suppression techniques may be used.

The first process further comprises outputting the first signal 16 to the first audio channel 10 after the noise suppression.

The second processor 8 performs a second process on the second signal 18. The first process comprises more aggressive noise suppression than the second process. More specifically, the second process does not comprise noise suppression. The second process comprises outputting the second signal 18 to the second audio channel 12. The second process does not result in as much attenuation of transmission end noise as the first process, but preserves the quality of the desired audio. In the present example, the second processor 8 simply passes the second signal 18 unchanged to the second audio channel 12. However, it will be appreciated that in some embodiments, the second processor 8 may perform some processing on the second signal 18, for example, amplification, time delay and/or gentle noise suppression of the second signal 18.

The difference in noise suppression between the first signal 16 and the second signal 18 means that when the first and second audio channels are arranged spatially on opposite sides of the listener (possibly through headphones or speakers), the listener perceives undistorted speech (the desired audio) playing on the side of the second audio channel, spatially separated from the transmission end noise. This means that even though the overall level of noise has not been reduced, the spatial separation of the received audio from the received noise results in speech that is more intelligible and can be understood with less effort.

The perceived spatial separation of the desired audio and the transmission end noise is further enhanced by the first process comprises introducing a time delay to the first signal 16 before outputting the first signal 16 to the first audio channel 10. The time delay is slight (e.g. 10 ms).

In an example where the mobile phone is connected to a pair of headphones, the first audio channel 10 supplies the first signal 16 to a first speaker of the pair of headphones and the second audio channel 12 supplies the second signal 18 to a second speaker of the pair of headphones. The first speaker may be a first ear bud, and the second speaker may be a second ear bud.

In order to reduce the likelihood of the user listening only to the aggressively noise suppressed signal with degraded audio intelligibility, the second speaker (which plays the audio with less aggressive noise suppression) is connected to an in-line microphone. As the listener may use the in-line microphone to transmit their own speech during a telephone conversation, they are less likely to stop listening to the second speaker during the telephone conversation.

In another example, the input audio signal 14 is a stereo signal, which comprises a first input signal and a second input signal. The receiver uses the first input signal as the first signal 16 and the second input signal as the second signal 18. The effect of the perceived spatial separation can be further improved if the first input signal and second input signal come from two different microphones, with the second input signal comprising more noise than the first input signal.

While a specific example has been described relating to mobile phones it will be appreciated that it may be applied to other devices, such as tablets or laptops. Additionally, while a specific example has been described relating to speech audio, it will be appreciated that it may be applied to other types of audio signals.

Additionally, while a specific example has been described relating to the use of a pair of headphones, it will be appreciated that the first audio channel 10 and the second audio channel 12 may be supplied to speaker such as built in audio systems for cars.

FIG. 2 is a flowchart illustrating method steps performed by the noise suppressor 2 of FIG. 1 according to an example embodiment of the present invention.

At step S210, the receiver 4 receives an input audio signal 14. Further in step S210, although not illustrated, the receiver 4 decodes the input audio signal 14. For example, the receiver 4 decodes the input audio signal 14 by using Enhanced Voice Services codec. The receiver 4 may duplicate the decoded audio signal to produce a first signal 16 and a second signal 18. The receiver 4 may send the first signal 16 to the first processor 6 and send the second signal 18 to the second processor 8.

At step S220, the receiver 4 performs a first process on the first signal 16. The first process comprises noise suppression which removes at least a portion of the transmission end noise from the first signal 16. The noise suppression used in the first process may be aggressive noise suppression. The receiver 4 may output the first signal 16 to the first audio channel 10 after the noise suppression.

At step S230, the receiver 4 performs a second process on the second signal 18. The second process may include a less aggressive noise suppression than in the first process, or no noise suppression at all. For example, the second process may include amplification, time delay and/or gentle noise suppression of the second signal 18. The receiver 4 may output the second signal 18 to the second audio channel 12. The second processor 8 may output the second signal 18 to the second audio channel 12 unchanged, or after performing the second process on the second signal 18 (e.g., amplification, time delay, and/or noise suppression).

However, the present exemplary embodiment is not limited to the flowchart of FIG. 2. For example, the receiver 4 may perform a first process on the first signal 16 and a second process on the second signal 18 at the same time. Alternatively, the receiver 4 may perform a first process on the first signal 16, after the receiver 4 perform a second process on the second signal 18.

According to the method described above, audio intelligibility of an input audio signal may be improved.

According to an alternative aspect of the present invention, the noise suppressor may control the amount of noise suppression on the receiver side based on the amount of noise present in the input audio signal.

In an example where the input audio signal is a speech signal, when a person speaking is in a reasonably quiet environment, the transmitter end noise suppression may be able to effectively remove all the audible background noise, or if the person speaking is in a very quiet room, then there may be no audible background noise to remove. For both of these cases, the transmitted speech is effectively “clean”, i.e. noise free, and additional noise suppression at the receiver end is unnecessary as such noise suppression may potentially distort the input audio signal. A mechanism within the receiver terminal is therefore needed to control whether to apply the receiver end noise suppression based on the noise level in the input audio signal.

One way of achieving this control includes using a Voice Activity Detector (VAD) which may analyze the received speech signal to identify when the person is not speaking. The VAD may further measure the noise level between periods during which the person is not speaking and compare the measured noise level during those periods to a threshold. If the measured noise level in the gaps is below the threshold, this indicates that no significant background noise is present, and the VAD may send a message or flag to the first processor 6 or second processor 8 to indicate that additional noise suppression processing is unnecessary. If the measured noise level is above the threshold, or no clear gaps are found by the VAD, this indicates that significant background noise is still present, and the VAD may send a message or flag to the first processor 6 or second processor 8 to indicate the additional receiver based noise suppression should be activated.

Alternatively the above described control can be applied intrinsically within the receiver end noise suppressor, since well-designed noise suppression would include steps of estimating the amount of background noise present and altering the amount of applied suppression based on the estimated background noise. In this way, if the background noise is very low (e.g., inaudible), the noise suppressor will not apply any suppression.

Although a few preferred embodiments have been shown and described, it will be appreciated by those skilled in the art that various changes and modifications might be made without departing from the scope of the invention, as defined in the appended claims.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

What is claimed is:

1. A noise suppressor comprising:
a receiver operable to receive an input audio signal and to produce from the input audio signal a first signal and a second signal, the input audio signal comprising desired audio and transmission end noise;
a first processor operable to perform a first process on the first signal, the first process comprising noise suppression to remove at least a portion of the transmission end noise from the first signal before outputting the first signal to a first audio channel; and
a second processor operable to perform a second process on the second signal, the second process comprising outputting the second signal to a second audio channel.

2. The noise suppressor of claim 1, wherein
the second process comprises noise suppression, and
the noise suppression of the first process is more aggressive than the noise suppression of the second process.

3. The noise suppressor of claim 1, wherein the second process does not comprise noise suppression.

4. The noise suppressor of claim 1, wherein the first process further comprises introducing a time delay to the first signal before outputting the first signal to the first audio channel.

5. The noise suppressor of claim 1, wherein the input audio signal is a mono audio signal, and the receiver is operable to duplicate the input audio signal to produce the first signal and the second signal.

6. The noise suppressor of claim 1, wherein the input audio signal is a stereo audio signal comprising a first input signal and a second input signal, and the receiver is operable to use the first input signal as the first signal and the second input signal as the second signal.

7. The noise suppressor of claim 1, wherein the noise suppression of the first process is carried out using a Weiner filter.

8. The noise suppressor of claim 1, wherein the input audio signal is a speech signal.

9. The noise suppressor of claim 1, wherein the receiver comprises a decoder operable to decode the input audio signal.

10. The noise suppressor of claim 8, wherein the decoder is an Enhanced Voice Services decoder.

11. The noise suppressor of claim 1, wherein the first audio channel is operable to supply the first signal to a first speaker of a pair of headphones and the second audio channel is operable to supply the second signal to a second speaker of the pair of headphones.

12. The noise suppressor of claim 11, the noise suppressor operable to:
receive from the pair of headphones a signal that only the first speaker is being used; and
on receiving the signal that only the first speaker is being used, outputting the first signal to the first audio channel without noise suppression of the first signal.

13. The noise suppressor of claim 11 or 12, wherein the second speaker is connected to an in-line microphone.

14. A mobile phone comprising a noise suppressor, the noise suppressor comprising:
a receiver operable to receive an input audio signal and to produce from the input audio signal a first signal and a second signal, the input audio signal comprising desired audio and transmission end noise;
a first processor operable to perform a first process on the first signal, the first process comprising noise suppression to remove at least a portion of the transmission end noise from the first signal before outputting the first signal to a first audio channel; and
a second processor operable to perform a second process on the second signal and output the second signal to a second audio channel after performing the second process,
wherein the first process comprises noise suppression.

15. A method of improving audio intelligibility comprising:
receiving an input audio signal and producing from the input audio signal a first signal and a second signal, the input audio signal comprising desired audio and transmission end noise;
performing a first process on the first signal, the first process comprising noise suppression to remove at least a portion of the transmission end noise from the first signal before outputting the first signal to a first audio channel; and
performing a second process on the second signal, the second process comprising outputting the second signal to a second audio channel,
wherein the first process comprises more aggressive noise suppression than the second process to provide a perceived spatial separation of the desired audio and the transmission end noise to a listener.
